(19) United States
(12) Patent Application Publication
(10) Pub. No.: US 2016/0358290 A1
(43) Pub. Date: Dec. 8, 2016

(54) HEALTH SEVERITY SCORE PREDICTIVE MODEL

(71) Applicant: Humana Inc., (US)

(72) Inventors: Sandy Chiu, Louisville, KY (US); Vipin Gopal, Louisville, KY (US)

(73) Assignee: HUMANA INC., Louisville, KY (US)

(21) Appl. No.: 13/863,498

(22) Filed: Apr. 16, 2013

Related U.S. Application Data
(60) Provisional application No. 61/636,089, filed on Apr. 20, 2012.

(51) Int. Cl. G06Q 50/22; G06F 19/00

(52) U.S. Cl. CPC G06Q 50/22; G06F 19/328

(57) ABSTRACT

A computerized health severity score predictive model for assigning a health severity score to a member of a health insurance member population is disclosed. The computerized system and method comprises a predictive model for scoring members. The predictive model is developed based on health insurance claim data. Member claim data may comprise eligibility, demographics, medical claims, pharmacy claims, pharmacy benefit management, laboratory test results, and disease management data. A utilization transition pattern is identified from a comparison of costs observed during a first year and a subsequent year. Members are segmented into groups according to predetermined segmenting rules derived from a segmentation model that applies the utilization transition pattern. The health severity score is thus based on demographic and clinical data as well as utilization transition pattern (or cost transition) data.

### CROSS-REFERENCE TO RELATED APPLICATIONS

This application claims the benefit of U.S. Provisional Patent Application Ser. No. 61/636,089, filed on Apr. 20, 2012, titled Health Severity Score Predictive Model, which is incorporated herein by reference.

### BACKGROUND OF THE ART

Rising healthcare costs and concerns about increasing the availability and quality of healthcare for all have lead to an increased use of predictive models to identify those patients most likely to have a need for specific types of healthcare services. The ability to identify predictors of different health problems and diseases and apply them to patient populations can be important in determining where patients should be directed for additional care. Predictors are useful in identifying patients likely to benefit from various intervention and prevention programs so that future healthcare problems are avoided or minimized and related costs are reduced.

U.S. Pat. No. 7,725,329 describes one system and method for predicting a person's future health status based on various clinical measures. Using medical and pharmacy claim data from a health benefits provider, the presence of clinical conditions is determined and based on the clinical conditions, a person's future health status is predicted. Although the presence or absence of various clinical conditions is important to predicting a person's health status, consideration of other factors may increase the accuracy of the predictive model. There is a need for an improved predictive model for measuring a person's future health status.

### SUMMARY OF THE INVENTION

Using predictive modeling, collected data can identify at risk members of an insurance member population such that members may be identified early as requiring preventative or intervening measures, ultimately leading to faster recovery and lower medical costs.

A computerized system and method according to an exemplary embodiment comprises a predictive model for identifying health risk in health insurance member population. A predictive model is developed based on historical data and integrated in a model software application that applies patient data as input and outputs a health severity score indicating a member's risk of health conditions. In an exemplary embodiment, a computer processor extracts features from a database containing claims data from members, transforms the extracted features, and selects the transformed features having the strongest predictive power. In the next step, insurance members are segmented into groups according to predetermined segmenting rules derived from a pre-trained segmentation model. The segmentation model is trained by applying a utilization transition pattern. In the next step, the selected transformed features of the segmented members in each group are then optimized. After optimization, the representing optimized features of a member are inputted into one of the meta-models, outputting a health severity score. A meta-model comprises at least one learning algorithm combining the outputs from diverse learning algorithms and predictive models to boost predictive power.

In one example, member historical data may comprise eligibility, demographics, medical claims, pharmacy claims, pharmacy benefit management, laboratory test results, and disease management. A utilization transition pattern is identified from a comparison of costs observed during a first year and a subsequent year. The health severity score is thus based on demographic and clinical data as well as cost transition data. In another example, the meta-model for each population segment, under the control of a processor, may comprise algorithms such as multivariate linear regression (MVLR), least angle regression (LARS), neural network (NN), and classification and regression tree (CART). Where a health severity score is a combination of outputs from more than one learning algorithm and predictive model, in one example, the mean value of the health severity scores may be calculated. In another example, the maximum value of health severity scores is assigned.

### BRIEF DESCRIPTION OF THE DRAWINGS

FIG. 1 is a block diagram of the model structure.

FIG. 2 is a diagram illustrating the utilization transition pattern or cost transition index for the predictive model.

FIG. 3 is a block diagram illustrating the data input and feature extraction for the model.

FIG. 4 is a diagram illustrating the process of feature transformation.

FIG. 5 is a diagram illustrating the process of segmenting a member population into subpopulations comprising homogenous features.

FIG. 6 is a diagram illustrating utilization transition patterns observed over two years.

FIG. 7 a segmentation model illustrating segmenting rules is shown.

### DETAILED DESCRIPTION OF A PREFERRED EMBODIMENT

In an exemplary embodiment, a learning predictive model is integrated in a model software application for use by a health compensation payer to predict a member's health status.

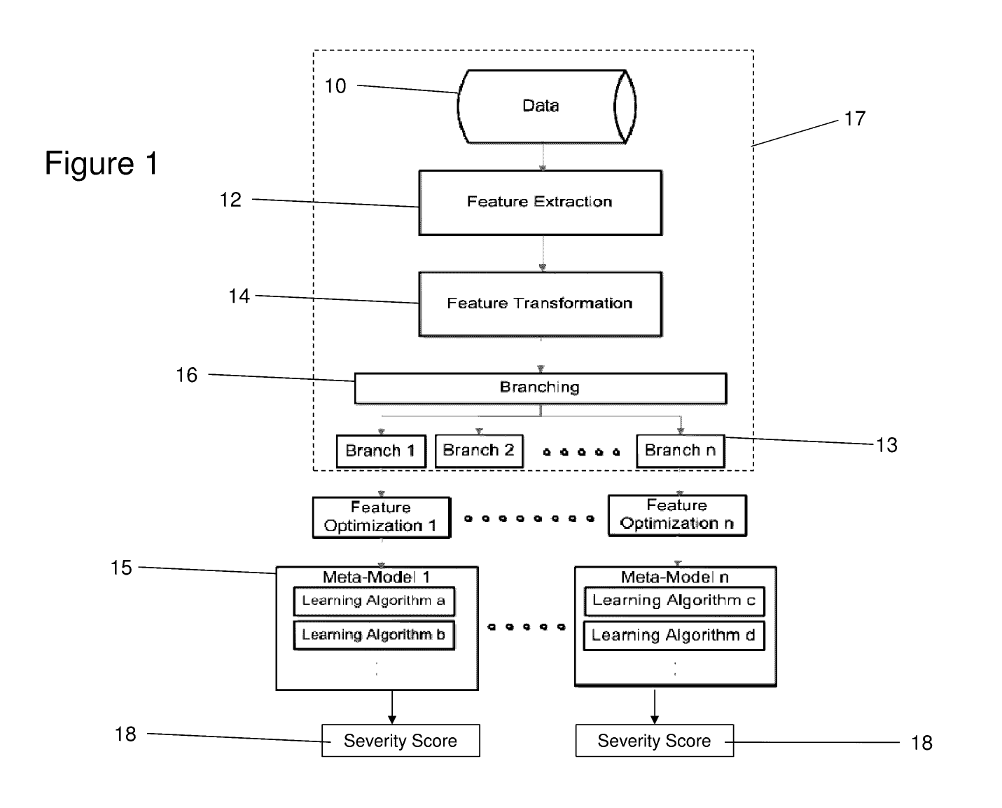

Referring to FIG. 1, in an exemplary embodiment, a block diagram illustrates the process of how a predictive model collects data 10, mines the collected data based on both clinical knowledge and data-driven predictive power to optimize feature extraction 12, and transforms and uses the optimized features to generate a health severity score 18.

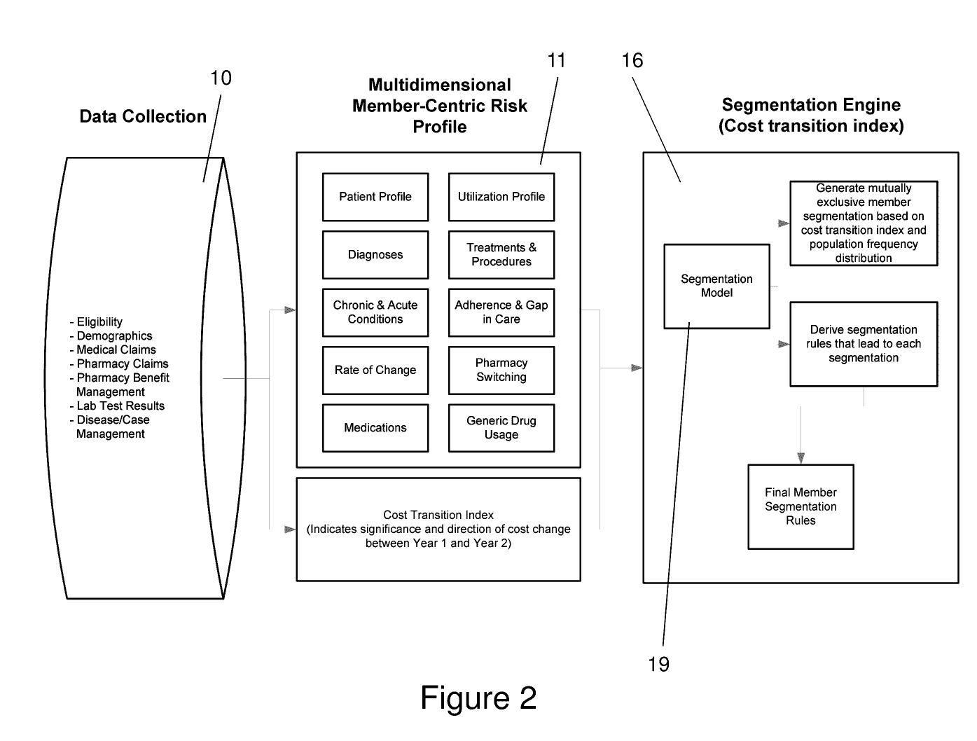

As shown in FIG. 1, in an exemplary embodiment, features are mined from a large volume of data 10 for information relevant to predicting health status, commonly known as feature extraction 12. As described more fully below, in the process of feature transformation 14, new features, or predictor variables, are created and regularized. Subsequently, members are selected or grouped into homogenous populations in a process known in the art as branching 16. The process of feature extraction, transformation, and segmentation are defined by box 17 and more fully described in FIG. 2.

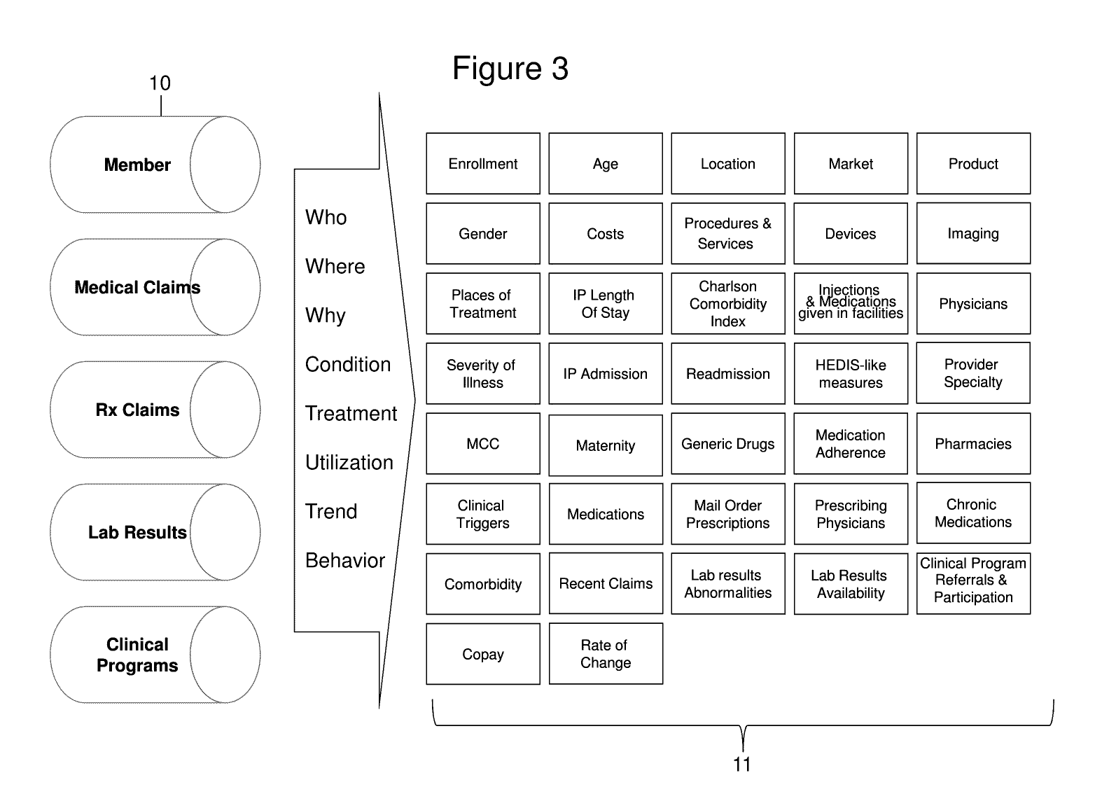

As shown in FIG. 2, a further description of the feature extraction, transformation, and segmentation process is illustrated. Referring to FIG. 2, data 10 is collected from a health insurance member population. Data 10 collected includes, but is not limited to, eligibility, demographics, medical claims, pharmacy claims, pharmacy benefit management data, laboratory test results, and disease and case management data. The process of feature extraction 12 results in the generation of features 11. Such examples of features 11 include, but are not limited to, patient profile, diagnoses, medications, treatment and procedures, generic drug use, and laboratory test results. In addition, cost features are extracted. In an example embodiment, one of the cost features is a cost transition index which, in an example embodiment, indicates the significance and direction of cost change between a first year and a second year. Additional exemplary features are more fully described in FIG. 3.

A segmentation engine 16 comprising a segmentation model 19 generates mutually exclusive member segmentations based on the cost transition index and a population frequency distribution. Segmentation rules that lead to each segmentation are then derived from the model.

Referring to FIG. 3, a block diagram is shown illustrating data inputs and feature extraction. As shown in FIG. 3, in an exemplary embodiment, collected data 10 is processed and features 11 extracted. Resulting extracted features are subsequently transformed. Data is mined and processed reducing redundant data or data that is void of any predictive value.

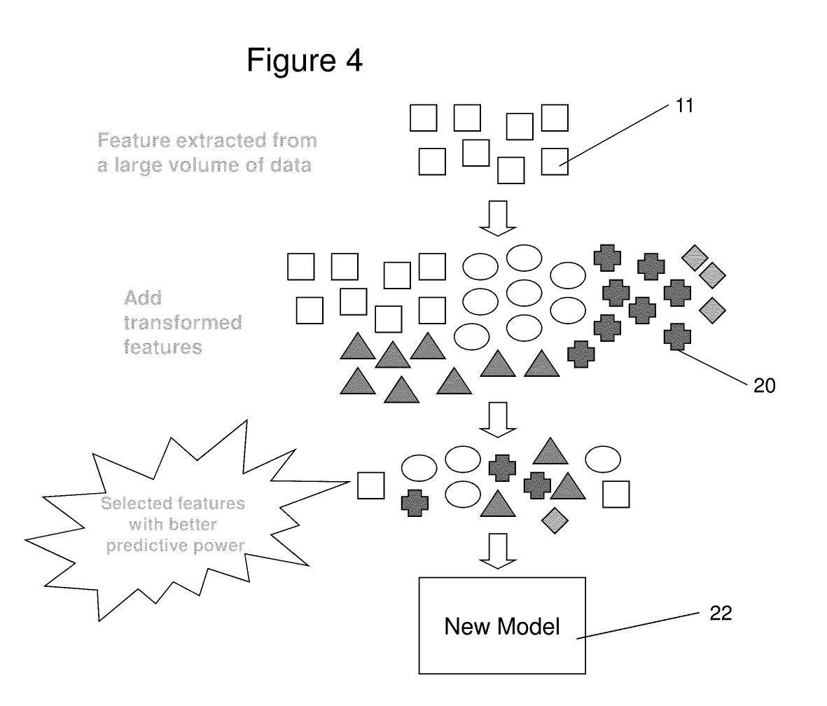

Referring to FIG. 4, a diagram is shown illustrating the process of feature transformation and feature selection. As illustrated in FIG. 4, in an exemplary embodiment, extracted features 11 are transformed and new features 20 are added and accessed by the predictive model 22 under the control of a processor to generate a health severity score 18.

In one example, the selected features are regularized according to methods known in the art. Applying mathematical, statistical, and data transformation functions to the extracted features, improves robustness to outlying data. The feature transformation step identifies a subset of available features and inputs them into a predictive model comprising a meta-model learning algorithm. The predictive model 22, under the control of a processor, evaluates the individual and combined predictive power of the extracted and transformed features 11, selecting a subset of the most relevant features based on its predictive power. Regularization and feature transformation, when combined together, generate a more accurate health severity score 18. In one exemplary embodiment, computational considerations are also taken into account.

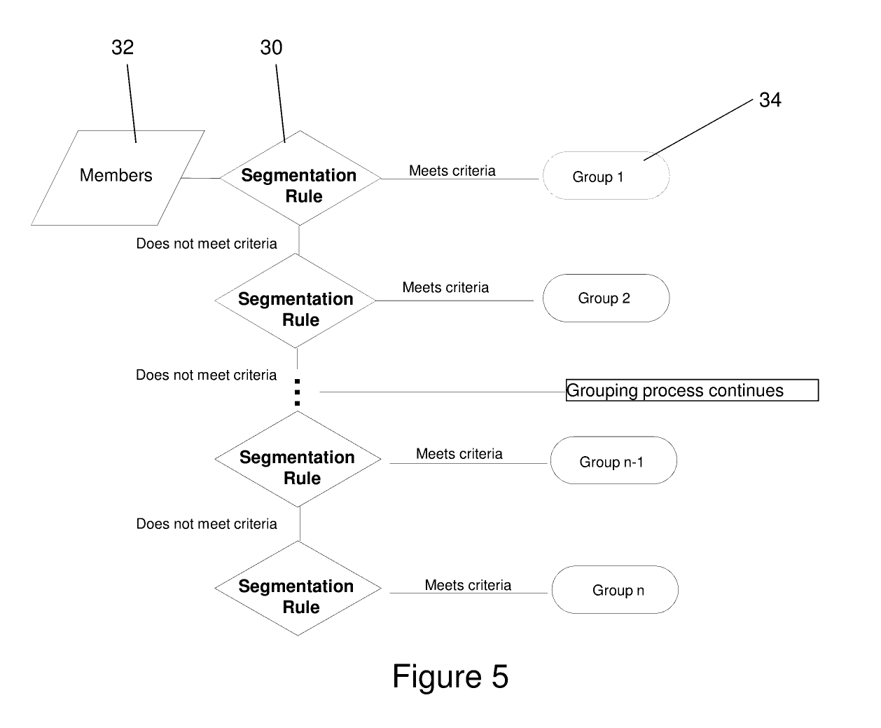

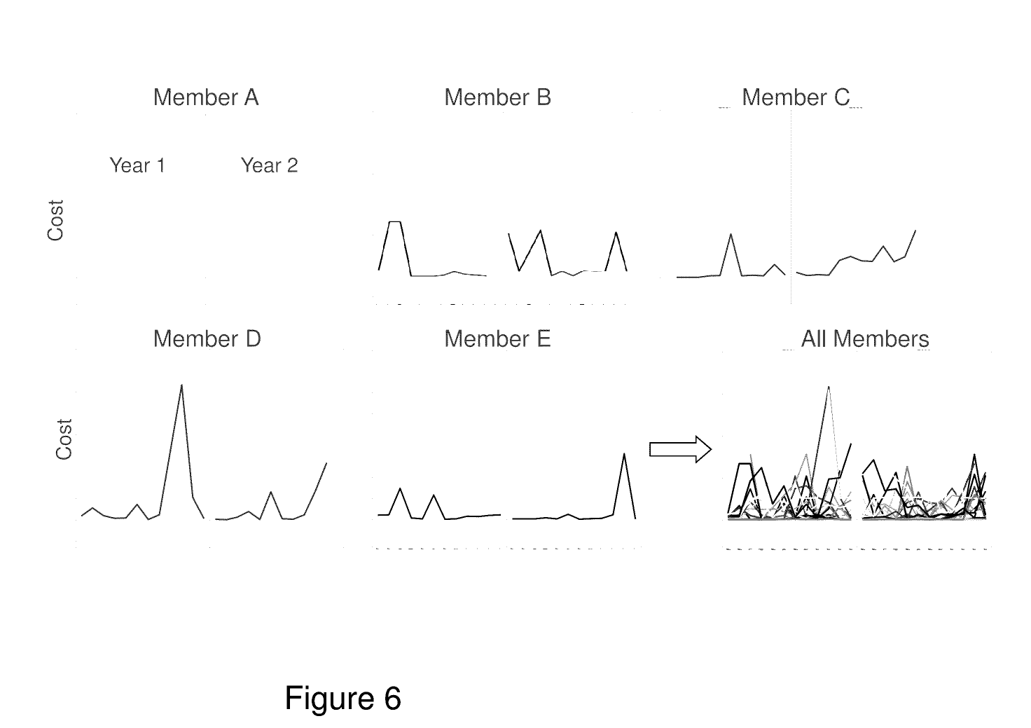

Referring to FIG. 5, a diagram illustrating the process of segmenting a member population into subpopulations comprising homogenous features is shown. As illustrated in FIG. 5, in one exemplary embodiment, the member population is segmented into subpopulations comprising a selection of the member population exhibiting the same or similar features. Segmentation is performed by the segmentation engine under the control of a processor according to a plurality of segmentation rules 30. One example of a segmentation rule 30 may comprise a segmentation model trained on observed utilization transition patterns. In an example embodiment, a utilization transition pattern, otherwise known as a cost transition index, is based on two years of utilization. Transition patterns are more fully described below in FIG. 6. The segmentation engine segments members 32 into homogenous groups 34 based on the learned segmenting rules. In another example, segmentation rules 30 may comprise segmenting members 32 based on population frequency distribution. Other examples of segmentation rules 30 may comprise segmenting members into groups 34 based on a combination of the cost transition index and the population frequency distribution. The group's 34 features are optimized selecting for the most concise feature sets for the homogenous group.

Referring to FIG. 6, example cost transition indexes are shown. As illustrated in FIG. 6, in one exemplary embodiment, the cost transition index value indicates the significance and direction of cost change between one year's cost and a subsequent year's cost. This approach is used because it is usually more difficult to predict a second year's cost when a member has high-to-low, or low-to-high cost transitions from one year to the next year. In one example, members who have low cost or short coverage in the first year may be excluded from the segmentation model as those members are healthier or they do not have sufficient claims data. In one example, members may be excluded from the segmentation model when the per-member per-month cost is less than a specified amount such as $27. In another example, members may be excluded from the segmentation where the duration of coverage is less than three months.

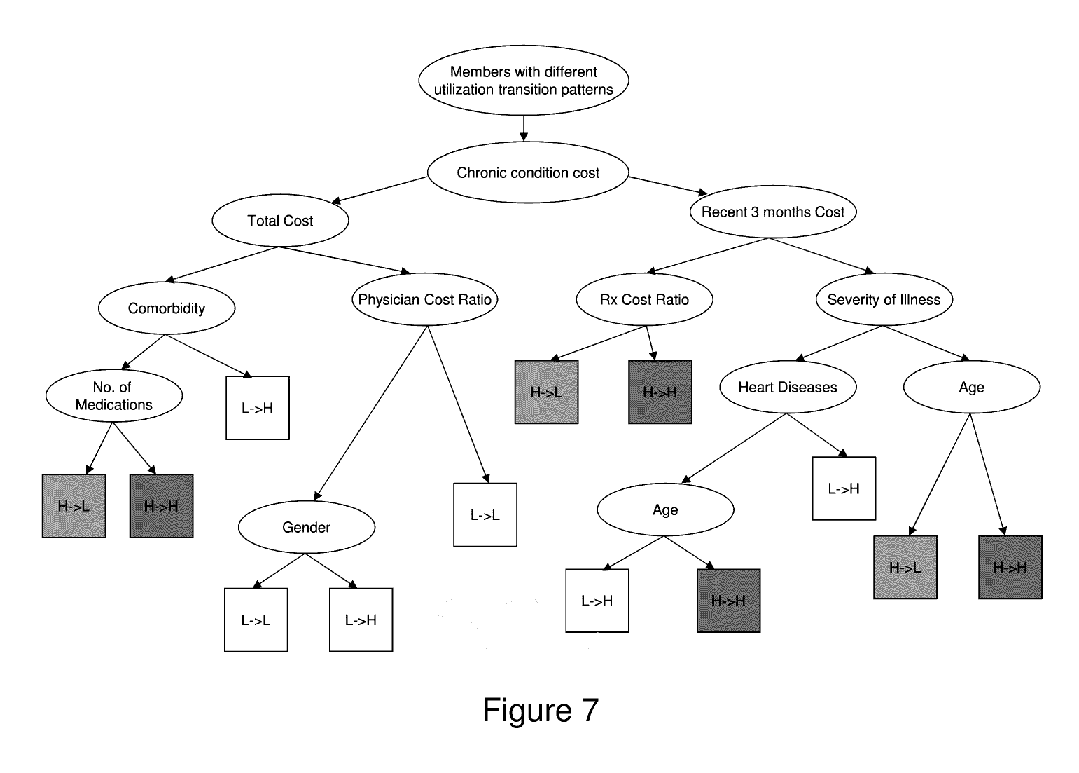

Referring to FIG. 7, a segmentation model illustrating segmenting rules to identify members with different utilization transition patterns is shown. As illustrated in FIG. 7, in one exemplary embodiment, segmentation rules are obtained from a supervised segmentation model based on a plurality of feature decisions based on demographic data (e.g., age, gender), clinical conditions (e.g., comorbidity, number of medications, heart disease, severity of illness) as well as costs (e.g., chronic condition cost, total cost, recent cost, physician cost ratio, prescription cost ratio). Segmentation rules are derived from a series of data-driven branching rules. In one example, the branching rules are based on both clinical and cost data-driven insights.

Referring again to FIG. 1, once members have been segmented into homogenous groups 13, a subset of available features 11, are identified and input to a learning algorithm 15. Learning algorithms 15 include, but are not limited to, multivariate linear regression (MVLR), Least Angle Regression (LARS), neural network (NN), classification and regression tree (CART), or a combination of multiple models for best prediction (ensemble). In one example, a group may be scored by one of these exemplary learning algorithms 15 or scored by various combinations of learning algorithms 15 implemented to generate a health severity score 18. Combining learning algorithms 15, or meta-models, mitigate the potential for statistical error observed when using only one model. In addition, multiple models alleviate the need to build a large and complex model otherwise needed to achieve statistical diversity. The exploitation of multiple simpler learning algorithms increases the efficiency of the process.

Having shown and described a preferred embodiment of the invention, those skilled in the art will realize that many variations and modifications may be made to affect the described invention and still be within the scope of the claimed invention. Thus, many of the elements indicated above may be altered or replaced by different elements which will provide the same result and fall within the spirit of the claimed invention. It is the intention, therefore, to limit the invention only as indicated by the scope of the claims.

1. A computerized method for assigning health severity scores to members of a health insurance population comprising:
(a) extracting at a server from at least one health claims database utilization data for a plurality of members of said health insurance population, said utilization data comprising for each member cost data for said member;
(b) identifying at said server for each of said plurality of members a utilization transition pattern based on a comparison of a first year of cost data and a second year of cost data;
(c) segmenting members at said server in to a plurality of groups based on data driven rules derived from a supervised segmentation model;
(d) integrating at said server a predictive model trained on member data and observed utilization transition patterns with a model software application that:
(1) applies said predictive model to member data for said plurality of members; and
(2) assigns to each of said plurality of members a health severity score based on application of said predictive model; and
(3) outputs for each member said health severity score.

2. The computerized method of claim 1 wherein said utilization data is selected from the group consisting of:
demographic and geographical data, membership and plan benefit data, medical, pharmacy, lab, dental and vision claims data, pharmacy benefit management data, clinical data, lab test results data, care management, disease management and health program data, socio-economic data, health risk assessment and survey data, call center, messaging and weblogs data, electronic medical records data, biometric data, and healthcare provider data.

3. The computerized method of claim 1 wherein said demographic and geographical data comprises data selected from the group consisting of:
age, gender, location, market and plan data.

4. The computerized method of claim 1 wherein said clinical data comprises data selected from the group consisting of:
comorbidity, number of medications, heart disease, severity of illness, and treatments.

5. The computerized method of claim 1 wherein said cost data comprises data selected from the group consisting of:
chronic condition cost, total cost, recent cost, physician cost ratio, and prescription cost ratio.

6. The computerized method of claim 1 wherein said utilization transition pattern is a pattern selected from the group consisting of:
low to low costs, low to high costs, high to low costs, and high to high costs.

7. The computerized method of claim 1 wherein said utilization transition pattern indicates significance and direction between said first year of cost data and said second year of cost data.

8. The computerized method of claim 1 wherein said supervised segmentation model is developed on member data, clinical knowledge, utilization transition patterns, and cost transition indices.

9. A computerized system for assigning health severity scores to members of a health insurance population comprising:
(a) at least one health claims database comprising utilization data for a plurality of members; and
(b) a server executing instructions to:
(1) extract at said server from said at least one health claims database utilization data for a plurality of members of said health insurance population, said utilization data comprising for each member cost data for said member;
(2) identify at said server for each of said plurality of members a utilization transition pattern based on a comparison of a first year of cost data and a second year of cost data;
(3) segment members at said server in to a plurality of groups based on data driven rules derived from a supervised segmentation model; and
(c) a model software application executing at said server with an integrated predictive model trained on member data and observed utilization transition patterns for a plurality of years that:
(1) applies at said server said predictive model to said member data for said plurality of members; and
(2) assigns to each of said plurality of members a health severity score based on application of said predictive model; and
(3) outputs for each member said health severity score.

10. The computerized system of claim 9 wherein said utilization data is selected from the group consisting of:
demographic and geographical data, membership and plan benefit data, medical, pharmacy, lab, dental and vision claims data, pharmacy benefit management data, clinical data, lab test results data, care management, disease management and health program data, socio-economic data, health risk assessment and survey data, call center, messaging and weblogs data, electronic medical records data, biometric data, and healthcare provider data.

11. The computerized system of claim 9 wherein said demographic and geographical data comprises data selected from the group consisting of:
age, gender, location, market and plan data.

12. The computerized system of claim 9 wherein said clinical data comprises data selected from the group consisting of:
comorbidity, number of medications, heart disease, severity of illness, and treatments.

13. The computerized system of claim 9 wherein said cost data comprises data selected from the group consisting of:
chronic condition cost, total cost, recent cost, physician cost ratio, and prescription cost ratio.

14. The computerized system of claim 9 wherein said utilization transition pattern is a transition selected from the group consisting of:
low to low costs, low to high costs, high to low costs, and high to high costs.

15. The computerized system of claim 9 wherein said utilization transition pattern indicates significance and direction between said first year of cost data and said second year of cost data.

16. The computerized system of claim 9 wherein said supervised segmentation model is developed on member data, clinical knowledge, utilization transition patterns, and cost transition indices.

17. A computerized method for assigning health severity scores to members of a health insurance population comprising:
(a) extracting at a server from at least one health claims database utilization data for a plurality of members of said health insurance population, said utilization data comprising cost data for each member;
(b) comparing at said server for each of said plurality of members a first year of cost data and a second year of cost data to identify a utilization transition pattern;
(c) segmenting said plurality of members at said server in to a plurality of groups based on data driven rules derived from a supervised segmentation model;
(d) integrating at said server a predictive model trained on member data and identified utilization transition patterns with a model software application that:
(1) applies said predictive model to member data for said plurality of members;
(2) assigns to each of said plurality of members a health severity score based on application of said predictive model; and
(3) outputs for each member said health severity score.

18. The computerized method of claim 17 wherein said cost data comprises data selected from the group consisting of:
chronic condition cost, total cost, recent cost, physician cost ratio, and prescription cost ratio.

19. The computerized method of claim 17 wherein said utilization transition pattern is a transition selected from the group consisting of:
low to low costs, low to high costs, high to low costs, and high to high costs.

20. The computerized method of claim 17 wherein said utilization transition pattern indicates significance and direction between said first year of cost data and said second year of cost data.
